(19) United States
(12) Patent Application Publication
(10) Pub. No.: US 2006/0189277 A1
(43) Pub. Date: Aug. 24, 2006

(54) Transceiver device with switching arrangement of improved linearity

(76) Inventors: Tero Ranta, Turku (FI); Juha Ella, Halikko (FI); Rodd Novak, San Diego, CA (US); Dylan Kelly, San Diego, CA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/064,110

(22) Filed: Feb. 23, 2005

(51) Int. Cl. H04B 1/44

(52) U.S. Cl. 455/78

(57) ABSTRACT

The present invention relates to a transceiver device having a switching arrangement and to a method of improving such a switching arrangement, wherein an input impedance of a duplexer means, as seen by a switching means (10) at a predetermined frequency, is transformed to a predetermined maximum or a minimum value. The switching means is used to selectively connect an antenna port to a transmitting and receiving path which leads to the duplexer means (14). The transformation of the input impedance can be achieved by providing a phase shifter (20) between a switching means (10) and the duplexer means (14). Thereby, the phase of the impedance can be optimized for minimal intermodulation distortion and to relax switch linearity requirements, so that the switching means (10) can be used for switching duplex signals.

### FIELD OF THE INVENTION

The present invention relates to a transceiver device having a switching arrangement for switching duplex signals and to a method of improving linearity of such an antenna switching arrangement. In particular, the present invention relates to antenna switches for mobile terminals of full-duplex mobile telecommunication systems.

### BACKGROUND OF THE INVENTION

In 3rd generation mobile communication systems, front-end architectures of mobile phones must be adapted to process full-duplex signals, e.g., Wideband Code Division Multiple Access (WCDMA) or CDMA signals. If such duplex signals are to be routed via an antenna switch from a common antenna of the mobile phone to the WCDMA receiver, very high linearity is required for the antenna switch. A reason for this is that the intermodulation (IMD) and crossmodulation (XMD) distortion levels must be as low as possible to meet system standards for mobile transceiver radio frequency performance.

Traditionally, in mobile phone front-ends for multiband and/or multimode use, e.g. Global System for Mobile Communication (GSM) and WCDMA, non-full-duplex GSM bands are routed through a GSM antenna switch, while WCDMA full-duplex signals are received via a separate WCDMA antenna and directly routed to the WCDMA duplexer. This approach has mainly been chosen to avoid having to use a highly linear antenna switch for the WCDMA duplex signals.

FIG. 5 shows a schematic block diagram of a conventional front-end architecture of a mobile phone for processing WCDMA and GSM signals. The WCDMA front-end portion is indicated as FIG. 5(b), wherein the WCDMA duplex bands comprise a receiving band ranging from 2.11 GHz to 2.17 GHz and a transmission band ranging from 1.92 GHz to 1.98 GHz. The WCDMA signals are received by a separate WCDMA antenna 16 which is directly connected to a WCDMA duplexer 14 configured to switch WCDMA signals received via a common transmission and receiving path to the upper receiving path, and to switch WCDMA transmission signals received via the lower transmission path to the WCDMA antenna 16 via the combined transmitting and receiving path.

Furthermore, FIG. 5(a) shows the GSM front-end portion, in which GSM signals received via a GSM antenna 18 are selectively connected by a GSM antenna switch 10 to different transmission and receiving (Rx) channels of four different GSM bands (quad-band GSM) ranging around 850 MHz, 900 MHz, 1800 MHz and 1900 MHz. Selective signal processing is achieved by providing a bank of filter circuits 12 for filtering transmission (Tx) and reception (Rx) bands.

However, in many cases, especially when there are more than one WCDMA or CDMA path, it would be desirable to be able to route a full-duplex signals through the antenna switch 10. As already mentioned, switching full-duplex signals through the antenna switch 10 leads to the problem of high linearity requirements. Antenna switches may be based on e.g. GaAs technologies, such as PHEMT (Pseudomorphic High Electron Mobility Transistor), or CMOS (Complementary Metal Oxide Semiconductor) technologies, such as SOI (Silicon-On-Insulator) or SOS (Silicon-On-Sapphire; a special case of SOI where sapphire is used as insulator). Regardless of the technology, linearity requirements are difficult to meet in view of the fact that current implementations are very close to specification limits and relaxation of linearity requirements would thus be desirable.

A demanding antenna switch linearity requirement for WCDMA systems is the out-of-band blocking case. Based on the 3GPP (3rd Generation Partnership Project) specification TS 25.101 (V6.4.0), a blocking signal is injected to the antenna port of the mobile phone. If the antenna switch linearity is not high enough, the intermodulation distortion products generated by mixing of the blocking signal (−15 dBm) and the own transmission signal (+20 dBm) may be located within the own receiving band. Thus, for WCDMA systems, these mixing products appear as additional noise components on the receiving signal and thus degrade sensitivity of the receiver.

FIG. 6 shows frequency diagrams relating to an example of out-of-band blocking as a result of intermodulation distortions in a WCDMA system. The left-hand frequency diagram shows the situation without intermodulation products (i.e. at the input of an antenna switch), where a blocking or blocker signal of a signal power of −15 dBm has a frequency of 1.76 GHz. The uplink signal spectrum has a bandwidth of 3.84 MHz at a center frequency of 1.95 GHz and at a signal power of +20 dBm. Finally, the receiving signal spectrum has a bandwidth of 3.84 MHz at a center frequency of 2.14 GHz and a signaling power of −99 dBm. If the uplink signal and the blocker signal are both received at a common antenna and mixing occurs due to the non-linearities of the antenna switch, e.g. with a third order distortion of IIP₃ (Input Third-Order Intercept)=+55 dBm, a signal spectrum as indicated in a frequency diagram on the right half of FIG. 6 will be generated at the output of the antenna switch. As can be gathered from the right-hand frequency diagram, additional frequency components have been generated around the blocking frequency of 1.76 GHz and around the receiving band at 2.14 GHz. In the present example, an intermodulation component of a signal power of −85 dBm at a frequency band of 7.68 MHz has been generated, so that the WCDMA receiving signal is buried under noise.

FIG. 7 shows a table indicating different WCDMA bands with transmission, receiving and blocking center frequencies. The maximum level of intermodulation distortion on the receiving band depends on the WCDMA receiver noise properties. Based on typical receiver properties and some margin, the maximum intermodulation distortion (IMD) on the receiving band for WCDMA would be −105 dBm when measured with a transmission signal of +20 dBm and a continuous wave (CW) blocking signal of −15 dBm. Based on these signal levels, the theoretical switch linearity requirements would be IIP₃=+65 dBm and IIP₂=+110 dBm. Due to these second and third order intermodulation distortions, antenna switches exhibit three dominating out-of-band blocking mechanisms. These mechanisms lead to mixing signals at f_{TX}+f_{S}=f_{RX} (second order distortions IMD₂), 2f_{TX}−f_{S}=f_{RX} (third order distortions IMD₃) and f_{S}−f_{TX}=f_{RX} (second order distortions IMD₂), wherein f_{TX} designates the frequency of the transmission signal, f_{RX} designates the frequency of the receiving signal, and f_{S} designates the frequency of the blocker signal.

### SUMMARY OF THE INVENTION

It is an object of the present invention to provide an improved antenna switching arrangement which allows routing of duplex signals through the antenna switch.

This object is achieved by a transceiver device having an antenna switching arrangement for switching duplex signals, comprising:
switching means for selectively connecting an antenna port to at least one transmitting and receiving path;
duplexer means for selectively connecting a receiver means or a transmitter means to said transmitting and receiving paths; and
phase shifting means arranged between said switching means and said duplexer means and configured to transform an input impedance of said duplexer means, as seen by said switching means at a predetermined frequency, to a maximum value or to a minimum value.

Furthermore, the above object is achieved by a method of improving linearity of an antenna switching arrangement, said method comprising the step of transforming an input impedance of a duplexer means, as seen by a switching means at a predetermined frequency, to a maximum or minimum value, said switching means being used to selectively connect an antenna port to a transmitting and receiving path leading to said duplexer means.

Accordingly, a suitable phase shifting function or phase shifter is added between the antenna switch and the duplexer to rotate the phase of the impedance which the antenna switch sees at the blocker or blocking frequency to an optimal value, e.g. maximum value (open circuit) or minimum value (short circuit). Thereby, full-duplex signals of WCDMA, CDMA or other wireless communication systems can be switched through the antenna switch which is thus optimized for such use. The proposed solution provides a way either to improve the linearity of current solutions or to relax the very demanding linearity requirements for conventional switching elements. By optimizing the phase of the impedance, intermodulation distortions can be minimized and switch linearity requirements can be relaxed.

The predetermined frequency may be a frequency of a blocking signal injected via the antenna port.

The receiver means may be a WCDMA or CDMA receiver.

Furthermore, the input impedance of the duplexer means may be in a matched state on its transmitting and receiving passbands.

The switching means, the duplexer means and the phase shifting means may be arranged on an integrated switch module. As an example, this integrated switch module may be a multiband and/or multimode antenna switch module. Implementation of the integrated switch module may be based on a wire bonded or flip chipped die on a laminate circuit board.

As specific examples, the phase shifting means may comprise at least one of a T-type low pass filter, a pi-type low pass filter, a T-type high pass filter and a pi-type high pass filter. Of course, other phase shifting circuits, such as delay lines or the like, may be used as well.

The input impedance may be transformed to the minimum value, if the switching means has a voltage-dependent non-linearity. Alternatively, the input impedance may be transformed to the maximum value, if the switching means has a current-dependent non-linearity.

Other advantageous modifications are defined in the dependent claims.

### BRIEF DESCRIPTION OF THE DRAWINGS

The present invention will now be described based on a preferred embodiment with reference to the accompanying drawings in which:

FIG. 1 shows a schematic block diagram of an antenna switching arrangement according to the preferred embodiment;

FIGS. 2A and 2B show circuit diagrams of implementation examples of a phase shifter configured as pi-type or T-type filter circuits;

FIG. 3 shows a Smith diagram indicating an input impedance of the duplexer at different frequencies;

FIG. 4 shows a diagram indicating distortion level versus relative phase shift between the antenna switch and the duplexer at a blocker frequency;

FIG. 5 shows a schematic block diagram of a conventional antenna switching arrangement with separate antenna for duplex signals;

FIG. 6 shows frequency diagrams at the input and at the output of the non-linear antenna switch;

FIG. 7 shows a table indicating intermodulation center frequencies for different WCDMA bands.

### DESCRIPTION OF THE PREFERRED EMBODIMENT

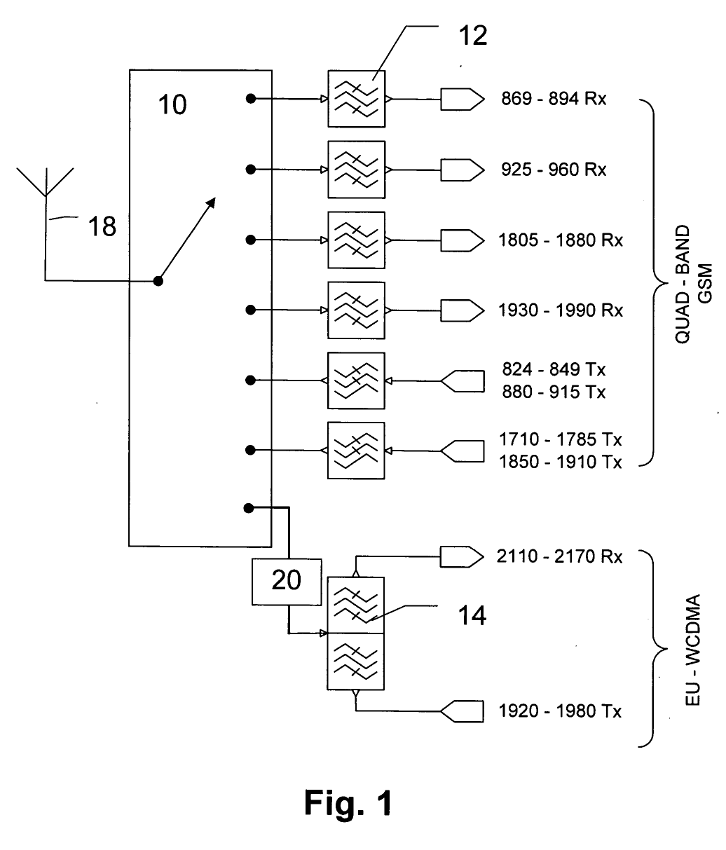

The preferred embodiment will now be described on a basis of a combined GSM and WCDMA mobile phone front-end architecture or transceiver architecture implemented as shown in FIG. 1.

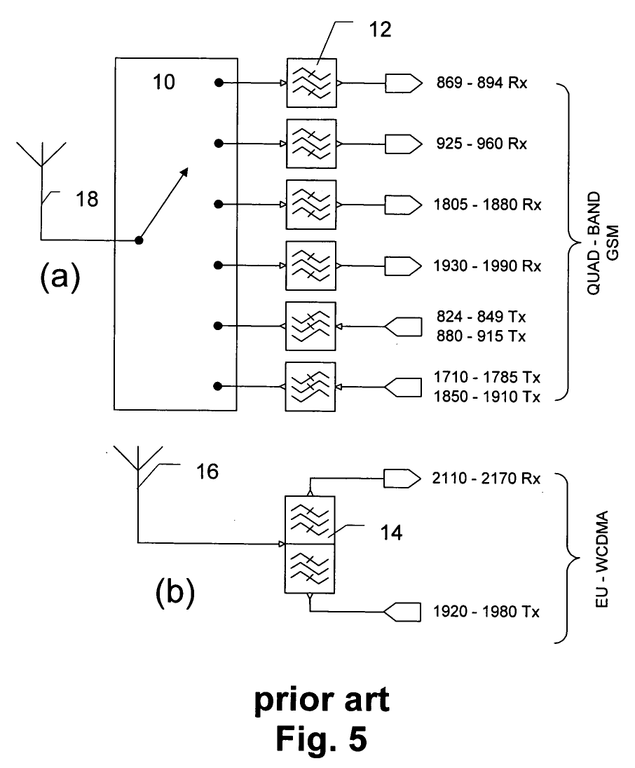

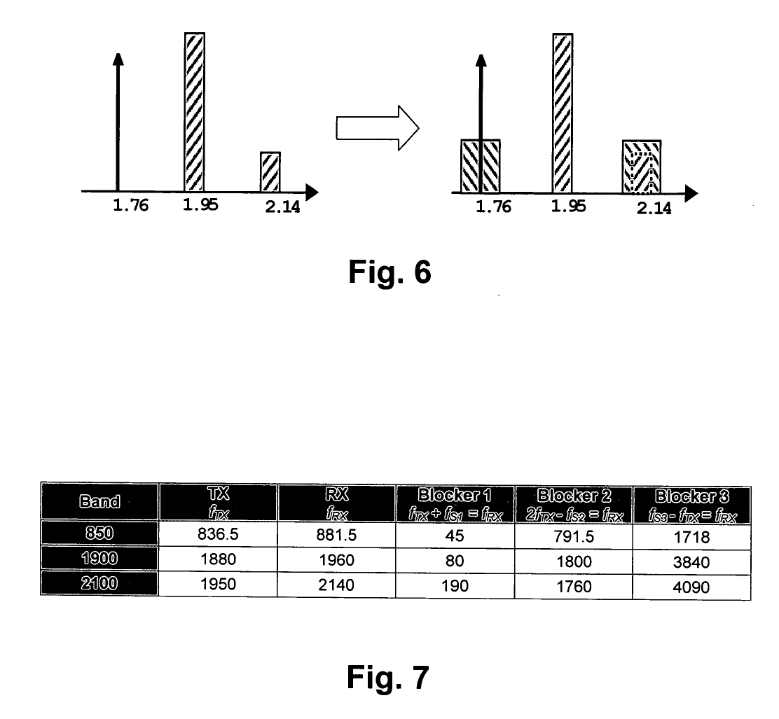

FIG. 1 shows a full-duplex (e.g. WCDMA) mobile phone transceiver architecture based on the conventional architecture of FIG. 5, wherein however both GSM simplex signals and WCDMA duplex signals are received through a single antenna 18 which is connected to an antenna switch 10 placed between the antenna port and the bank of filters 12 for filtering the respective transmission and reception bands of the GSM system.

Additionally, one output of the antenna switch 10 is connected via a phase shifter 20 to the WCDMA duplexer 14 for connecting either the receiving path or the transmitting path to the antenna switch via the phase shifter 20. The duplexer 14 permits simultaneous transmission and reception of data. It serves to emit the electrical output power, which may be very high at times, via the antenna 18 without interfering with the highly sensitive receiver which picks up the weak receiving signals. The duplexer 14 feeds the signals in the reception band to a low-noise amplifier of the mobile phone while suppressing all frequencies outside this band. It simultaneously connects the output of the mobile phone's power amplifier to the antenna 18. Its duplex function can be implemented by connecting two band pass filters together. The transmission filter is tuned to the transmission band, and the reception filter is tuned to the reception band. The antenna terminal to which the phase shifter 20 is connected and a λ/4 line which permits superposition of the transmit signals in the correct phase can be located between the receiving and transmitting filters. The duplexer 14 can be miniaturized by integrating circuit components using ceramic, SAW (Surface Acoustic Wave) or FBAR (Film Bulk Acoustic Resonator) technology.

The duplexer antenna port appears ideally matched (typically at 50Ω) on the duplexers transmission and reception passbands. On the other hand, it appears highly reflective on the stopbands. The intermodulation distortion blocker frequencies are on the stopband of the duplexer 14 and consequently see a highly reflective load, while the transmission signal sees a matched load.

The non-linearity mechanisms of the antenna switch 10 may be either voltage-dependent (e.g. non-linear shunt capacitance) or current-dependent (e.g. non-linear series resistance). If the non-linearity of the antenna switch 10 is governed by non-linear capacitance, the voltage levels of the drive signals determine the levels of the distortion products. In the mobile phone front-end, the transmission signal is matched and thus the transmission signal voltage level is fixed for a certain power level. However, the antenna switch 10 sees a highly reflective load at the duplexer antenna port on the blocker frequencies and consequently the blocker signal voltage level for a certain power level may be adjusted by changing the relative phase between the antenna switch 10 and the duplexer 14. For voltage-dependent non-linearity it is advantageous to minimize the peak voltage across the non-linear capacitance. This may be achieved by ensuring that the antenna switch 10 sees a short circuit (minimum voltage, maximum current) on the blocker signal frequencies. Similarly, the distortion products for current-dependent non-linearity may be minimized by adjusting the phase so that the switch sees an open circuit (maximum voltage, minimum current) at the blocker frequencies.

While the antenna switch 10 could be designed to be robust enough at any angle of impedance in the complex plane, this could lead to trade-offs elsewhere and compromise the other properties of the switch. It is therefore proposed to add the phase shifter 20 between the antenna switch 10 and the duplexer 14 or transmission filter so as to optimize the phase of the impedance for minimal intermodulation distortion and to relax the switch linearity requirements.

The phase shifter 20 is configured to rotate the phase of the impedance which the antenna switch 10 sees at the blocker frequency to an optimal value, i.e., open circuit or short circuit. The required absolute value or phase shift depends on the design of the duplexer 14 or its filters, the switching technology and the electrical distance between the antenna switch 10 and the duplexer 14.

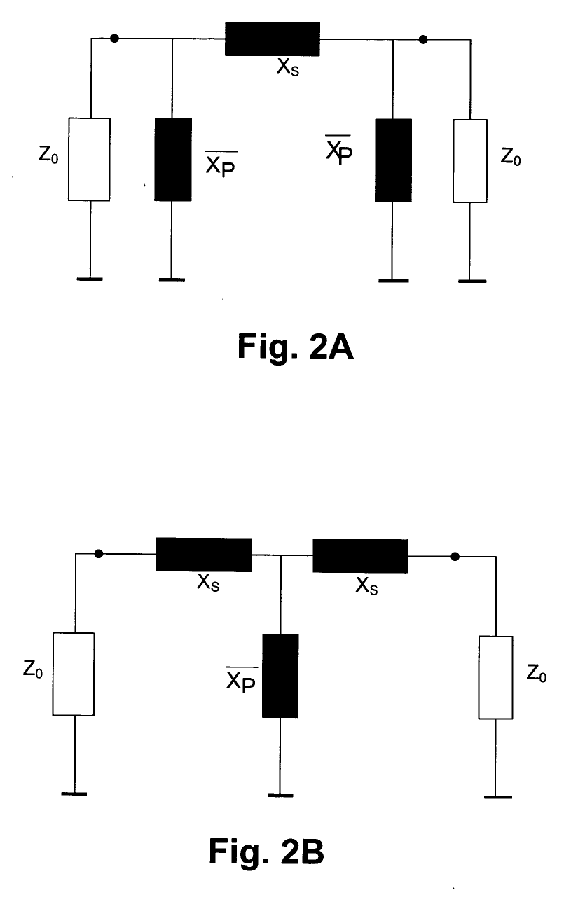

FIGS. 2A and 2B show examples for implementation of the phase shifter 20.

Four basic topologies could be used: a T-type low pass, a pi-type low pass, a T-type high pass and a pi-type high pass.

FIG. 2A shows the pi-type arrangement, wherein the resistances Z₀ correspond to the matching resistance (e.g. 50Ω). The black resistor symbols indicate serial reactance elements X_{S} and parallel reactance elements \overline{X_{P}}, which are related to each other by the equation X_{S}*\overline{X_{P}}=L/C, wherein L denotes the inductance of an inductive reactance and C denotes the capacitance of a capacity reactance, and wherein the reactance can be calculated based on the equations X=1/(2πfC) (capacity reactance) or X=2πfL (inductive reactance). Thus, the reactance elements may be realized as capacitors C or inductors L to thereby determine the filter characteristic of the phase shifter 20.

For example, if in FIG. 2A the serial reactance X_{S} is implemented by a capacitor C and the parallel reactances \overline{X_{P}} are implemented as inductors L, the phase shifter 20 corresponds to a pi-type high pass filter. On the other hand, if the serial reactance X_{S} is implemented by an inductor L and the parallel reactances \overline{X_{P}} are implemented by capacitors C, the phase shifter 20 corresponds to a pi-type low pass filter.

FIG. 2B shows an alternative implementation example for the phase shifter 20, wherein the reactances X_{S} and \overline{X_{P}} are connected in a T-type configuration. If the serial reactances X_{S} are implemented as capacitors C and the parallel reactance \overline{X_{P}} is implemented as an inductor L, the phase shifter 20 corresponds to a T-type high pass filter. On the other hand, if the serial reactances X_{S} are implemented as inductors L and the parallel reactance \overline{X_{P}} is implemented as a capacitor C, the phase shifter 20 corresponds to a T-type low pass filter.

To keep dimensions of the phase shifter 20 small, the inductor L can be implemented as a microstrip or stripline (e.g. buried strip) and the substrate material can be ceramic or organic. As an alternative, all elements can be implemented as discrete components or integrated on passive substrate like glass or silicon. The latter alternative occupies less space, but the Q-value of the circuit is slightly lower than the first alternative.

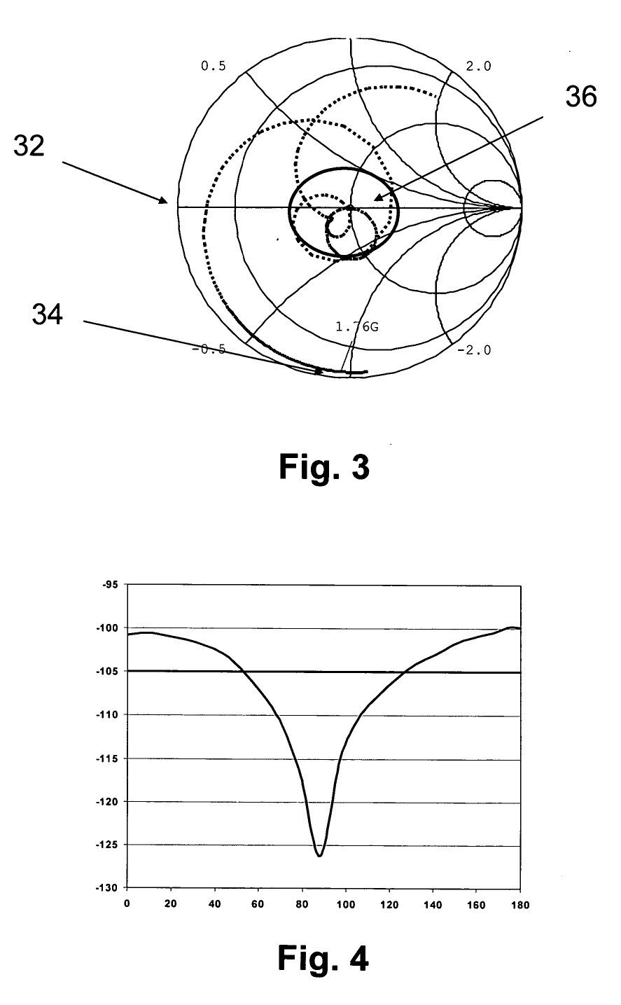

FIG. 3 shows a Smith diagram indicating the input impedance of the duplexer 14 as seen by the antenna switch 10 through the phase shifter 20. In the Smith diagram, the circular area 36 in the middle indicates an impedance close to the matching impedance of e.g. 50Ω, such that a matching condition is substantially obtained as long as the frequency-dependent impedance curve which is indicated by the bold dotted line stays within this area 36. Thus, the impedance curve within the circular area 36 corresponds to the impedance as seen by the output of the antenna switch 10 on the passbands of the duplexer 14. The lower area 34 of the diagram corresponds to a typical impedance of duplexer circuits at the blocker frequency (i.e. stopband) close to the “edge” of the circular Smith diagram. However, the circular angle of the discrete impedance value in the complex plane may vary. The left area 32 of the diagram corresponds to a desirable zero impedance and thus a short circuit for voltage-dependent non-linearity of the antenna switch 10. Consequently, the impedance as seen at the output of the antenna switch 10 should be rotated by the phase shifter 20 from the lower area 34 to the left area 32, if the antenna switch 10 has a voltage-dependent non-linearity. Thereby minimal intermodulation distortions can be achieved. On the other hand, if the antenna switch 10 has a current-dependent non-linearity, the phase shifter 20 should rotate the impedance seen at the output of the antenna switch 10 from the lower point 34 at the blocker frequency or stopband to the right area of the Smith diagram (opposite to the area 32) so as to obtain an open circuit characteristic and thus minimize distortions due to current-dependent non-linearities.

FIG. 4 shows a diagram indicating third order distortions IMD₃ [dBm] at 2.14 GHz (vertical axis) versus relative phase shift [deg] introduced by the phase shifter 20 between the antenna switch 10 and the duplexer 14 at a blocker frequency (1.76 GHz) for WCDMA (horizontal axis). As can be gathered from FIG. 4, the IMD₃ level is below the specific limit line of −105 dBm within a predetermined range of relative phase shift. Therefore, it is proposed to include the phase shifter 20 to optimize the phase shift within the range indicated in FIG. 4 to optimize the phase of the impedance seen from the antenna switch 10 for minimal intermodulation distortion. The concrete implementation and circuit components of the phase shifter 20 can then be obtained in a straight forward manner based on the desired phase shift.

The circuit arrangement of FIG. 1 can be implemented as a switch module which includes the antenna switch 10, the phase shifter 20 and the duplexer 14, so that the whole system can be optimized for proper matching and phase rotation between the antenna switch 10 and the duplexer 14. This switch module can be a multiband/multimode antenna switch module, for example a GSM and WCDMA engine. Physically, the switch module can be a wire bonded or flip chipped die on a laminate organic or LTCC (Low Temperature Co-fired Ceramic) board which also includes the wire bonded or flip chipped bare die or chip scaled filters. The matching could be integrated into the board or integrated passive die could be used.

In summary, a transceiver device with a switching arrangement and a method of improving such a switching arrangement have been described, wherein an input impedance of a duplexer means, as seen by a switching means at a predetermined frequency, is transformed to a predetermined maximum or a minimum value. The switching means is used to selectively connect an antenna port to a transmitting and receiving path which leads to the duplexer means. The transformation of the input impedance can be achieved by providing a phase shifter between a switching means and the duplexer means. The provision of the phase adjustment between the switching means and the duplexer means reduces linearity requirements of the switching means for duplex signals, as non-linear distortions can be suppressed. This leads to the advantage of optimized performance of the switching means for such use. Thereby, the phase of the impedance can be optimized for minimal intermodulation distortion and to relax switch linearity requirements, so that the switching means can be used for switching duplex signals.

It is to be noted that the present invention is not restricted to the above preferred embodiment, and can be used in connection with any kind of transceiver device having a combination of antenna switches and duplexers so as to route duplex signals through the antenna switch. Moreover, any kind of phase shifting circuitry can be used to implement the phase shifter 20, i.e. to introduce the required rotation or transformation of the input impedance of the duplexer 14 to the optimized impedance value. The preferred embodiments may thus vary within the scope of the attached claims.

1. A transceiver device having a switching arrangement for switching duplex signals, said device comprising:
a) switching means for selectively connecting an antenna port to at least one transmitting and receiving path;
b) duplexer means for selectively connecting a receiver means or a transmitter means to said at least one transmitting and receiving path; and
c) phase shifting means disposed between said switching means and said duplexer means and configured to transform an input impedance of said duplexer means, as seen by said switching means at a predetermined frequency, to a maximum value or to a minimum value.

2. A transceiver device according to claim 1, wherein said predetermined frequency is a frequency of a blocking signal injected via said antenna port.

3. A transceiver device according to claim 1, wherein said receiver means comprises a WCDMA or CDMA receiver.

4. A transceiver device according to claim 1, wherein said input impedance of said duplexer means is in a matched state on its transmitting and receiving passbands.

5. A transceiver device according to claim 1, wherein said switching means, said duplexer means and said phase shifting means are disposed on an integrated switch module.

6. A transceiver device according to claim 5, wherein said integrated switch module comprise a multiband or multimode antenna switch module.

7. A transceiver device according to claim 5, wherein said integrated switch module comprises a wire bonded or flip chipped die on a laminate circuit board.

8. A transceiver device according to claim 1, wherein said phase shifting means comprises one of a T-type low pass filter circuit, a pi-type low pass filter circuit, a T-type high pass filter circuit and a pi-type high pass filter circuit.

9. A mobile phone, said mobile phone comprising a transceiver device according to claim 1.

10. A method of improving linearity of an antenna switching arrangement, said method comprising the step of:
transforming an input impedance of a duplexer means, as seen by a switching means at a predetermined frequency, to a maximum or minimum value, said switching means being used to selectively connect an antenna port to a transmitting and receiving path leading to said duplexer means.

11. A method according to claim 10, wherein said transforming step comprises transforming said input impedance to said minimum value if said switching means has a voltage-dependent non-linearity.

12. A method according to claim 10, wherein said transforming step comprises transforming said input impedance to said maximum value if said switching means has a current-dependent non-linearity.

13. The transceiver device for switching duplex signals, said device comprising:
a switch for selectably connecting an antenna port to at least one transmitting and receiving path;
a duplexer for selectively connecting one of a receiver and a transmitter to the at least one transmitting and receiving path; and
a phase shifter disposed between the switch and the duplexer, said phase shifter configured to transform an input impedance of the duplexer, as seen by the switch at a predetermined frequency, to one of a maximum value and a minimum value.

14. The transceiver device as recited in claim 13, wherein said phase shifter transforms the input impedance of the duplexer as seen by the switching means at a frequency of a blocking signal injected via the antenna port.

15. The transceiver device as recited in claim 13, wherein the receiver comprises one of a WCDMA and CDMA receiver.

16. The transceiver device as recited in claim 13, wherein said input impedance of said duplexer is in a matched state in transmitting and receiving passbands.

17. The transceiver device as recited in claim 13, wherein said switch, said duplexer, and said phase shifter are disposed on an integrated switch module.

18. The transceiver device according to claim 17, wherein said integrated switch module comprises one of a multiband and multimode antenna switch module.

19. The transceiver device according to claim 17, wherein said integrated switch module comprises one of a wire bonded and flip-chipped die on a laminate circuit board.

20. The transceiver device according to claim 13, wherein said phase shifter comprises one of a T-type low pass filter circuit, a pie-type low pass filter circuit, a T-type high pass filter circuit, and a pie-type high pass filter circuit.

21. A mobile phone comprising a transceiver device according to claim 13.
